(19) United States
(12) Patent Application Publication
(10) Pub. No.: US 2026/0265078 A1
(43) Pub. Date: Sep. 10, 2026

(54) CATHODE ACTIVE MATERIAL AND METHOD FOR MANUFACTURING SAME

(71) Applicant: INDUSTRY-UNIVERSITY COOPERATION FOUNDATION HANYANG UNIVERSITY ERICA CAMPUS, Ansan-si (KR)

(72) Inventors: Jin Ho BANG, Ansan-si (KR); Ye Jin KIM, Ansan-si (KR); Jin Ha SHIM, Ansan-si (KR)

(21) Appl. No.: 19/656,769

(22) Filed: Apr. 23, 2026

Related U.S. Application Data
(63) Continuation of application No. PCT/KR2024/016469, filed on Oct. 25, 2024.

(30) Foreign Application Priority Data
Oct. 27, 2023 (KR) 10-2023-0145202
Aug. 23, 2024 (KR) 10-2024-0113238

(51) Int. Cl. C01G 53/506; H01M 4/02; H01M 4/525

(52) U.S. Cl. CPC C01G 53/506; H01M 4/525; C01P 2002/20; C01P 2002/32; C01P 2002/89; C01P 2004/04; C01P 2006/40; H01M 2004/028

(57) ABSTRACT

A method for manufacturing a cathode active material includes the steps of: preparing a preliminary cathode active material precursor containing nickel and manganese; preparing a doping source containing cobalt; providing the preliminary precursor into the doping source, followed by refluxing reaction, thereby preparing a cathode active material precursor; and mixing the cathode active material precursor and a lithium precursor, followed by firing, thereby manufacturing the cathode active material.

### CROSS-REFERENCE TO RELATED APPLICATION

This application is a bypass continuation of pending PCT International Application No. PCT/KR2024/016469, which was filed on Oct. 25, 2024, and which claims priority to and the benefit of Korean Patent Application No. 10-2023-0145202 filed with the Korean Intellectual Property Office on Oct. 27, 2023, and Korean Patent Application No. 10-2024-0113238 filed with the Korean Intellectual Property Office on Aug. 23, 2024, the disclosures of which are incorporated herein by reference in their entirety.

### TECHNICAL FIELD

The present disclosure relates to a cathode active material and a method for manufacturing the same, and more specifically, to a cathode active material containing a lithium metal, a nickel metal, a manganese metal, and a dopant, and a method for manufacturing the same.

### BACKGROUND ART

A cathode active material refers to an active material that exists in a cathode material of a secondary battery and electrochemically generates electrical energy.

The cathode active material present in the cathode material has lithium ions in an initial state, and serves to provide lithium ions to a cathode during a charging process of the secondary battery.

Accordingly, the cathode active material is used in various industries such as lithium metal batteries, lithium air batteries, lithium ion polymer batteries, etc.

As an application field increases, various cathode active materials are being studied. For example, Korean Patent Registration Publication No. 10-0815583 discloses a method for manufacturing a cathode active material for a lithium secondary battery, the method including: mixing a metal salt aqueous solution, which contains a first metal including nickel, cobalt and manganese, and optionally a second metal, a chelating agent, and a basic aqueous solution to prepare a co-precipitation compound; drying or heat-treating the co-precipitation compound to prepare an active material precursor; and mixing and firing the active material precursor and a lithium salt to prepare a lithium composite metal oxide, in which the lithium composite metal oxide has a layered structure.

### DISCLOSURE

### Technical Problem

One technical object of the present disclosure is to provide a cathode active material with an improved rate-limiting property under a high-speed charge/discharge condition.

Another technical object of the present disclosure is to provide a cathode active material with improved stability against charge/discharge cycles under a high-speed charge/discharge condition.

Still another technical object of the present disclosure is to provide a method for manufacturing a cathode active material with a reduced manufacturing process cost.

Still another technical object of the present disclosure is to provide a method for manufacturing a cathode active material with a shortened manufacturing time.

Still another technical object of the present disclosure is to provide a method for manufacturing a cathode active material that is easy to mass-produce.

The technical problems to be solved by the present disclosure are not limited to the above-described problems.

### Technical Solution

In order to solve the above technical problems, the present disclosure may provide a method for manufacturing a cathode active material.

According to one embodiment, the method for manufacturing the cathode active material may include: preparing a preliminary cathode active material precursor containing nickel and manganese; preparing a doping source containing cobalt; providing the preliminary cathode active material precursor into the doping source, followed by refluxing reaction, thereby preparing a cathode active material precursor; and mixing the cathode active material precursor and a lithium precursor, followed by firing, thereby manufacturing the cathode active material.

According to one embodiment, a crystal structure of a surface of a primary particle of the cathode active material and a crystal structure of an inside thereof may be differently controlled by the preparing of the cathode active material precursor.

According to one embodiment, in the preparing of the cathode active material precursor, a refluxing reaction temperature may be controlled to be 84° C. or less, and a refluxing reaction time may be controlled to be eight hours or less.

According to one embodiment, the preliminary cathode active material may be a transition metal hydroxide containing nickel and manganese, and the doping source may be a cobalt nitrate solution.

According to one embodiment, there may be provided the method for manufacturing the cathode active material, the method including: doping cobalt on a surface of the transition metal hydroxide containing nickel and manganese to prepare the cathode active material precursor, followed by firing together with the lithium precursor, in which the cathode active material precursor is primarily heat-treated at a first temperature, and the primarily heat-treated cathode active material precursor is secondarily heat-treated at a second temperature higher than the first temperature, and crystal structures of a surface and inside of a primary particle of the cathode active material are differently and identically controlled according to the second temperature.

According to one embodiment, the second temperature may be controlled to be at least 700° C. and less than 800° C., in which the crystal structure of the inside of the primary particle of the cathode active material may be controlled to have a layered structure, and the crystal structure of the surface thereof may be controlled to have a spinel structure by cobalt.

According to one embodiment, a rate-limiting property and stability against charge/discharge cycles may be improved under a condition of 5 C by the different crystal structures of the surface and inside of the primary particle of the cathode active material.

In order to solve the above technical problems, the present disclosure may provide a cathode active material manufactured by above-described manufacturing method.

According to one embodiment, there may be provided the cathode active material having cobalt doped on a surface of a composite metal oxide containing lithium, nickel, and manganese, in which crystal structures of a surface and inside of a primary particle of the cathode active material are different from each other, the inside of the primary particle has a layered structure, and the surface of the primary particle has a spinel structure.

According to one embodiment, the crystal structure of the surface of the cathode active material may be converted into a rock salt structure when a charge/discharge cycle is performed on the cathode active material.

According to one embodiment, the spinel structure present at a distance of 9.4 nm or less from the surface of the cathode active material may be converted into the rock salt structure when 100 charge/discharge cycles are performed on the cathode active material under a condition of 5 C.

### Advantageous Effects

A method for manufacturing a cathode active material according to the present disclosure may include: preparing a preliminary cathode active material precursor containing nickel and manganese; preparing a doping source containing cobalt; providing the preliminary cathode active material precursor into the doping source, followed by refluxing reaction, thereby preparing a cathode active material precursor; and mixing the cathode active material precursor and a lithium precursor, followed by firing, thereby manufacturing the cathode active material.

In the preparing of the cathode active material precursor, cobalt may be doped on a surface of the preliminary cathode active material precursor, and in the manufacturing of the cathode active material, a second temperature at which the cathode active material precursor and the lithium precursor are secondarily heat-treated may be controlled to be at least 700° C. and less than 800° C., thereby providing the cathode active material in which a surface of the primary particle has a spinel structure and an inside of the primary particle has a layered structure

The cathode active material manufactured by above-described manufacturing method may be doped with cobalt along a surface of a composite metal oxide containing lithium, nickel, and manganese.

In addition, as described above, the inside of the primary particle of the cathode active material may have a layered structure, and the surface of the primary particle of the cathode active material may have a spinel structure.

Accordingly, when a lithium secondary battery having the cathode active material applied thereto is subjected to charge/discharge cycles under a high-speed charge/discharge condition (e.g., 5 C), the discharge capacity and energy density of the lithium secondary battery may be improved due to the layered structure of the inside of the cathode active material, the spinel structure of the surface of the cathode active material may act as a passivation layer, and a three-dimensional channel shape for lithium ion diffusion may be provided to significantly improve a rate-limiting property and long-term stability against the charge/discharge cycles.

### DESCRIPTION OF DRAWINGS

FIG. 1 is a flowchart for describing a method for manufacturing a cathode active material according to an embodiment of the present disclosure.

FIG. 2 is a view for describing a preliminary cathode active material and a doping source according to an embodiment of the present disclosure.

FIG. 3 is a view for describing a method for manufacturing a cathode active material precursor according to an embodiment of the present disclosure.

FIG. 4 is a view for describing a method for manufacturing a cathode active material according to an embodiment of the present disclosure.

FIG. 5 is a view for describing a cathode active material according to an embodiment of the present disclosure.

FIGS. 6 to 8 are pictures and graphs for comparing the surfaces and insides of cathode active materials according to experimental example 1, comparative example 1, and experimental example 2 of the present disclosure.

FIG. 9 is a graph for comparing the rate-limiting properties of half cells according to experimental example 1 and comparative example 1 of the present disclosure.

FIG. 10 is a graph for comparing the stabilities of half cells against charge/discharge cycles according to experimental example 1, comparative example 2, and comparative example 2 of the present disclosure.

FIG. 11 is a graph for comparing the stabilities of full cells against charge/discharge cycles according to experimental example 1 and comparative example 1 of the present disclosure.

FIG. 12 is a graph for comparing the stabilities of crystal structures during charge/discharge of half cells according to comparative example 1 and experimental example 1 of the present disclosure.

FIGS. 13 and 14 are TEM pictures for comparing the crystal structures of cathode active materials after charge/discharge of half cells according to experimental example 1 and comparative example 1 of the present disclosure.

FIGS. 15 and 16 are graphs for comparing the resistance values against charge/discharge after performing charge/discharge of half cells according to comparative example 1 and experimental example 1 of the present disclosure.

FIGS. 17 and 18 are graphs for comparing the amounts of organic and inorganic matter layers on the surfaces of cathode active materials after charge/discharge of half cells according to comparative example 1 and experimental example 1 of the present disclosure.

FIGS. 19A, 19B, 20A and 20B show results of time of flight secondary ion mass spectrometry (TOF-SIMS) analysis on cathodes and anodes after charge/discharge of full cells according to comparative example 1 and experimental example 1 of the present disclosure.

### MODE FOR DISCLOSURE

Hereinafter, exemplary embodiments of the present disclosure will be described in detail with reference to the accompanying drawings. However, the technical spirit of the present disclosure is not limited to the embodiments described herein and may be implemented in other forms. Rather, the embodiments introduced herein are provided so that the disclosed contents may be thorough and complete and the spirit of the present disclosure may be sufficiently conveyed to those skilled in the art.

In the present specification, when a component is referred to as being on another component, it means that it may be formed directly on the other component or a third component may be interposed therebetween. In addition, in the drawings, the thicknesses of films and regions are exaggerated for effective description of the technical contents.

In addition, in various embodiments of the present specification, terms such as first, second, third, and the like are used to describe various components, but these components should not be limited by these terms. These terms have only been used to distinguish one component from another component. Accordingly, a component mentioned as a first component in one embodiment may be mentioned as a second component in another embodiment. Each embodiment described and exemplified herein includes a complementary embodiment thereof. In addition, in the present specification, “and/or” is used as a meaning including at least one of the components listed before and after.

In the specification, a singular expression includes a plural expression unless the context clearly indicates otherwise. In addition, terms such as “include,” “have” or the like are intended to designate the presence of features, numbers, steps, components, or combinations thereof described in the specification, and should not be understood to preclude the possibility of the presence or addition of one or more other features, numbers, steps, components, or combinations thereof. In addition, in the present specification, “connection” is used as a meaning including both indirectly connecting a plurality of components and directly connecting the plurality of components.

Furthermore, in the following description of the present disclosure, when it is determined that a detailed description of related known functions or configurations may unnecessarily obscure the subject matter of the present disclosure, the detailed description thereof will be omitted.

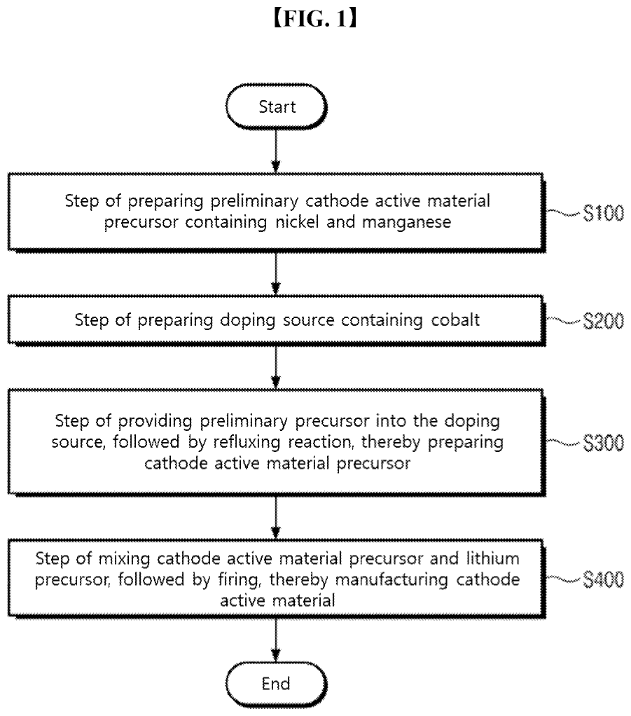

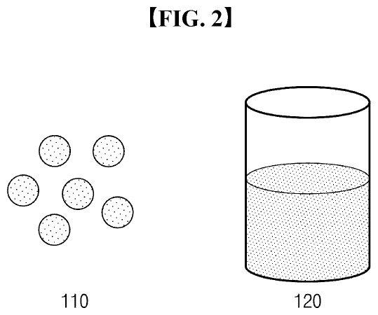

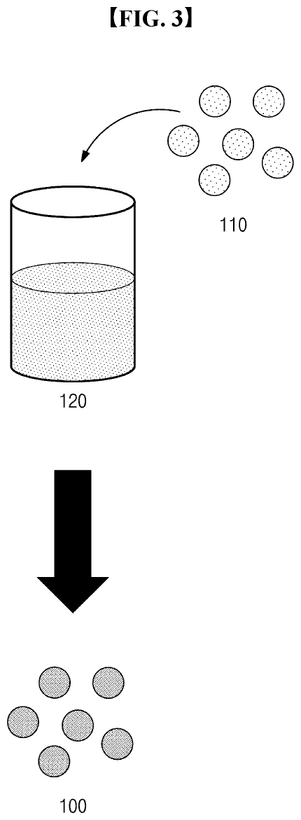

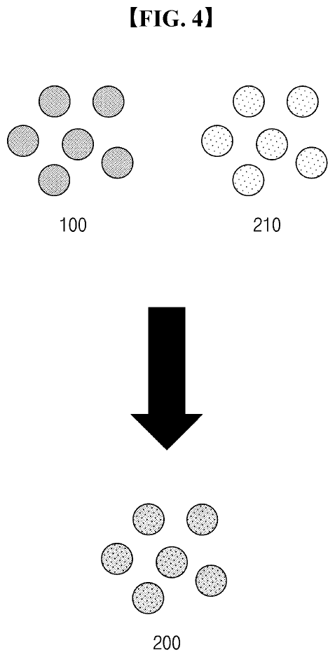

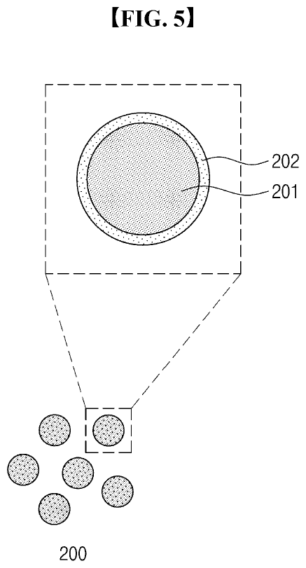

FIG. 1 is a flowchart for describing a method for manufacturing a cathode active material according to an embodiment of the present disclosure, FIG. 2 is a view for describing a preliminary cathode active material and a doping source according to an embodiment of the present disclosure, FIG. 3 is a view for describing a method for manufacturing a cathode active material precursor according to an embodiment of the present disclosure, FIG. 4 is a view for describing a method for manufacturing a cathode active material according to an embodiment of the present disclosure, and FIG. 5 is a view for describing a cathode active material according to an embodiment of the present disclosure.

Referring to FIGS. 1 and 2, a preliminary cathode active material precursor 110 containing nickel and manganese may be prepared (S100), and a doping source 120 containing cobalt may be prepared (S120).

The preliminary cathode active material precursor 110 may be a transition metal hydroxide containing nickel and manganese. For example, the preliminary cathode active material precursor 110 may be prepared by subjecting a nickel source and a manganese source to a co-precipitation reaction. For example, the chemical composition of the preliminary cathode active material precursor 110 may be Ni_{0.94}Mn_{0.06}(OH)₂.

In addition, the doping source 120 may be, for example, a cobalt nitrate solution. For example, the doping source 120 may be Co(NO₃)₂·6H₂O.

Referring to FIGS. 1 and 3, the preliminary cathode active material precursor 110 may be provided to the doping source 120 and subjected to a refluxing reaction to prepare a cathode active material precursor 100 (S300).

Specifically, the doping source 120 may be stirred in a reactor while being maintained at a specific temperature. For example, the temperature may be maintained at 84° C. or less. For example, the temperature may be a refluxing reaction temperature. For example, the stirring speed may be controlled to 200 rpm.

After that, the preliminary cathode active material precursor 110 may be provided to the reactor, and the doping source 120 and the preliminary cathode active material precursor 110 may be subjected to a refluxing reaction for a specific time. Accordingly, nickel on a surface of the preliminary cathode active material precursor 110 may be substituted with cobalt in the doping source 120. In other words, cobalt may be doped in the doping source 120 along the surface of the preliminary cathode active material precursor 110. Accordingly, the cathode active material precursor 100 having the surface doped with cobalt may be easily prepared. For example, the refluxing reaction temperature may be maintained at 84° C. or less. For example, a refluxing reaction time may be controlled to be eight hours or less. For example, the chemical composition of the cathode active material precursor 100 may be Ni_{0.88}Co_{0.06}Mn_{0.06}(OH)₂.

Accordingly, in the manufacturing of the cathode active material 200 to be described later by the cobalt doped on the surface of the cathode active material precursor 100, crystal structures of a surface and inside of a primary particle of the cathode active material 200 to be described later may be differently controlled.

On the contrary, when cobalt is not doped on the surface of the cathode active material precursor 100, in the manufacturing of the cathode active material 200 to be described later, the crystal structures of the surface and inside of the primary particle of the cathode active material 200 to be described later may not be differently controlled, even when the cathode active material precursor 100 and a lithium precursor 210 to be described later are mixed and fired under the same conditions. In other words, the crystal structures of the surface and inside of the primary particle of the cathode active material 200 to be described later may be identically controlled.

In addition, compared to a conventional preparation process of doping a cathode active material precursor with a doping metal by a solution process before firing the cathode active material precursor and the lithium precursor, a temperature of a heat treatment (e.g., 84° C. or less) may be reduced, and a time of the heat treatment (e.g., eight hours or less) may be significantly shortened to reduce not only a preparation process time for the doping process but also a preparation process cost.

Referring to FIGS. 1 and 4, the above-described cathode active material 200 may be manufactured by mixing the cathode active material precursor 100 and the above-described lithium precursor 210 and firing the resulting mixture (S400).

Specifically, the cathode active material precursor 100 and the lithium precursor 210 may be physically mixed. For example, the lithium precursor 210 may be LiOH·H₂O. For example, the cathode active material precursor 100 and the lithium precursor 210 may be mixed using a mixing device such that a molar ratio of a transition metal in the cathode active material precursor 100 and a molar ratio of lithium in the lithium precursor 210 might be 1:1.03.

After that, the resulting mixture of the cathode active material precursor 100 and the lithium precursor 210 may be provided to a reactor of a heat treatment furnace, so as to be primarily heat-treated at a first temperature and secondarily heat-treated at a second temperature higher than the first temperature. For example, the first temperature may be controlled to be 500° C. For example, the primary heat treatment time may be five hours. For example, the secondary heat treatment time may be 10 hours. In this case, the crystal structures of the surface and inside of the primary particle of the cathode active material 200 may be differently or identically controlled depending on the second temperature.

According to one embodiment, the second temperature may be controlled to be at least 700° C. and less than 800° C. Accordingly, the surface of the primary particle of the cathode active material 200 may have a spinel structure, and the inside of the primary particle of the cathode active material 200 may have a layered structure. Thus, a rate-limiting property of the lithium secondary battery and long-term stability against charge/discharge cycles may be improved under a condition of high-speed charge/discharge speeds (e.g., 5 C).

On the contrary, when the second temperature is controlled to be 800° C. or more, the surface and inside of the primary particle of the cathode active material 200 may have a layered structure. Thus, the rate-limiting property of the lithium secondary battery and long-term stability against charge/discharge cycles may be decreased under the high-speed charge/discharge condition (e.g., 5 C).

In addition, when the second temperature is controlled to be less than 700° C., crystallinity of the cathode active material 200 and ordering of the layered structure may be significantly reduced. Thus, an initial capacity of the lithium secondary battery, the rate-limiting property thereof, and long-term stability against charge/discharge cycles may be decreased under the high-speed charge/discharge condition (e.g., 5 C). In this case, for example, the second temperature may be 650° C.

Thus, in the method for manufacturing the cathode active material 200 according to an embodiment of the present application, the second temperature at which the cathode active material precursor 100 and the lithium precursor 210 are secondarily heat-treated may be controlled to be at least 700° C. and less than 800° C. Accordingly, the surface of the primary particle of the cathode active material 200 may have a spinel structure, and the inside of the primary particle of the cathode active material 200 may have a layered structure. Thus, it may be possible to provide a lithium secondary battery with improved rate-limiting property and long-term stability against charge/discharge cycles under the high-speed charge/discharge condition (e.g., 5 C).

Comprehensively, in the preparing of the cathode active material precursor 100, the surface of the preliminary cathode active material precursor 110 may be doped with cobalt, and in the manufacturing of the cathode active material 200, the second temperature at which the cathode active material precursor 100 and the lithium precursor 210 are secondarily heat-treated may need to be controlled to be at least 700° C. and less than 800° C., and thus the surface of the primary particle of the cathode active material 200 may have a spinel structure, and the inside of the primary particle of the cathode active material 200 may have a layered structure.

Consequently, the method for manufacturing the cathode active material 200 according to an embodiment of the present application may include: preparing the preliminary cathode active material precursor 110 containing nickel and manganese; preparing the doping source 120 containing cobalt; providing the preliminary cathode active material precursor 110 into the doping source, followed by refluxing reaction, thereby preparing the cathode active material precursor 100; and mixing the cathode active material precursor 100 and the lithium precursor 210, followed by firing, thereby manufacturing the cathode active material 200.

In the preparing of the cathode active material precursor 100, cobalt may be doped on the surface of the preliminary cathode active material precursor 110, and in the manufacturing of the cathode active material 200, the second temperature at which the cathode active material precursor 100 and the lithium precursor 210 are secondarily heat-treated may be controlled to be at least 700° C. and less than 800° C., thereby providing the cathode active material 200 in which the surface of the primary particle has a spinel structure and the inside of the primary particle has a layered structure Accordingly, it may be possible to provide the lithium secondary battery with improved rate-limiting property and long-term stability against charge/discharge cycles under the high-speed charge/discharge condition (e.g., 5 C).

Referring to FIGS. 1 to 5, the cathode active material 200 manufactured by the above-described manufacturing method will be described.

The cathode active material 200 may have cobalt doped along the surface of the composite metal oxide containing lithium, nickel, and manganese. For example, the chemical composition of the cathode active material 200 may be Li_{1.03}Ni_{0.88}Co_{0.06}Mn_{0.06}O₂.

In addition, as described above, the inside 201 of the primary particle of the cathode active material 200 may have a layered structure, and the surface 202 of the primary particle of the cathode active material 200 may have a spinel structure.

Accordingly, when the lithium secondary battery having the cathode active material 200 applied thereto is subjected to charge/discharge cycles under the high-speed charge/discharge condition (e.g., 5 C), the discharge capacity and energy density of the lithium secondary battery may be improved due to the layered structure of the inside 201 of the cathode active material 200, the spinel structure of the surface 202 of the cathode active material may act as a passivation layer, and a three-dimensional channel shape for lithium ion diffusion may be provided to significantly improve the rate-limiting property and long-term stability against the charge/discharge cycles.

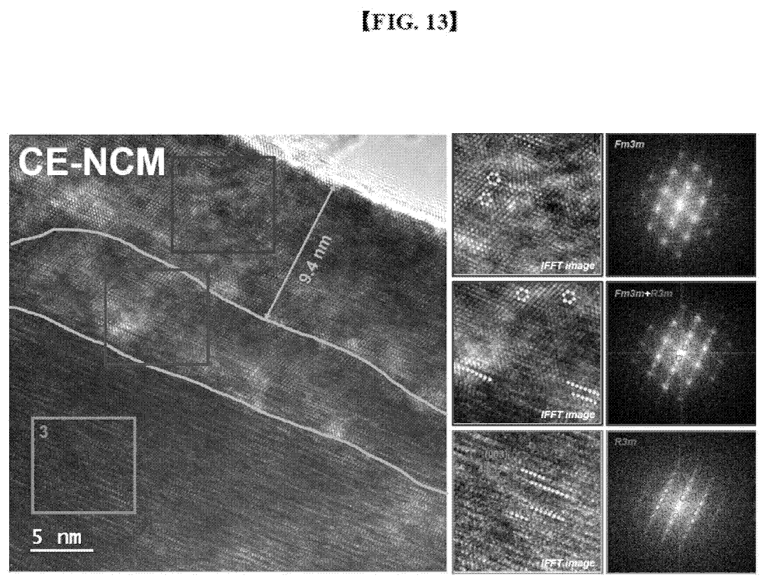

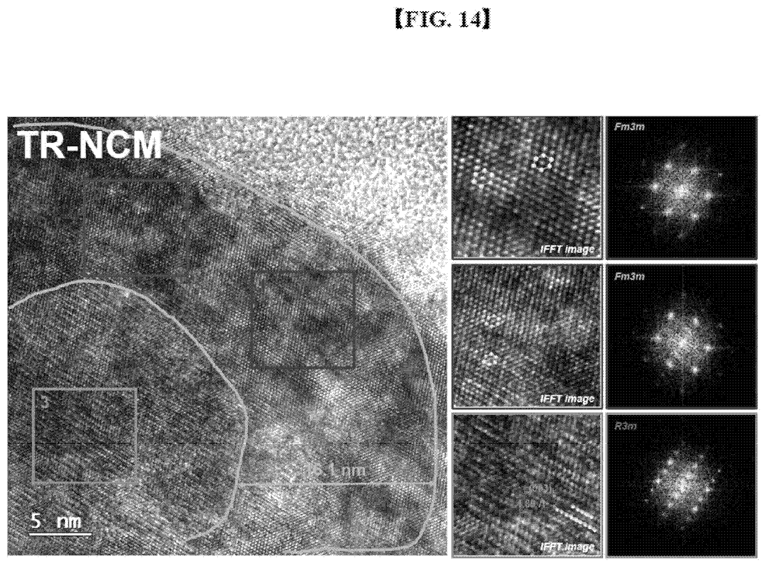

As a specific example, as will be described later with reference to FIGS. 13 and 14, when the lithium secondary battery having the cathode active material 200 applied thereto is subjected to 100 charge/discharge cycles under the condition of 5 C, a unique structure (internal: layered structure, external: spinel structure) of the cathode active material 200 may be maintained, except that the spinel structure present at a distance of 9.4 nm or less from the surface 202 of the cathode active material 200 is converted into a rock salt structure. This may mean that side reactions at an interface between the cathode active material 200 and electrolyte are effectively suppressed in the charge/discharge cycle process under the condition of 5 C.

Consequently, the cathode active material 200 according to an embodiment of the present application may be doped with cobalt along a surface of a composite metal oxide containing lithium, nickel, and manganese.

In addition, the inside 201 of the primary particle of the cathode active material 200 may have a layered structure, and the surface 202 of the primary particle of the cathode active material 200 may have a spinel structure.

Accordingly, when the lithium secondary battery having the cathode active material 200 applied thereto is subjected to charge/discharge cycles under the high-speed charge/discharge condition (e.g., 5 C), the discharge capacity and energy density of the lithium secondary battery may be improved due to the layered structure of the inside 201 of the cathode active material 200, the spinel structure of the surface 202 of the cathode active material may act as a passivation layer, and a three-dimensional channel shape for lithium ion diffusion may be provided to significantly improve the rate-limiting property and long-term stability against the charge/discharge cycles.

Hereinafter, specific experimental examples and property evaluation results of the cathode active material according to an embodiment of the present disclosure will be described.

### Cathode Active Material According to Experimental Example 1

A transition metal hydroxide (Ni_{0.94}Mn_{0.06}(OH)₂, 2g) was synthesized by a co-precipitation reaction, so as to be prepared as a preliminary cathode active material precursor, and a cobalt nitrate solution (Co(NO₃)₂·6H₂O, 3M, 100 mL) was prepared as a doping source.

In addition, the preliminary cathode active material precursor was provided while the doping source was stirred at 200 rpm and at 84° C., and subjected to a refluxing reaction for eight hours to prepare a cathode active material precursor (Ni_{0.88}Co_{0.06}Mn_{0.06}(OH)₂) doped with cobalt on a surface thereof.

Then, the cathode active material precursor and the lithium precursor (LiOH·H₂O) were physically mixed so that a molar ratio of a transition metal and lithium might be 1: 1.03, and then the resulting mixture was provided to a reactor of a tube heat treatment furnace, and a temperature of the reactor was raised from room temperature to a first temperature (500° C.) (2° C./min) and then primarily heat-treated for five hours. After that, the temperature of the reactor was raised from the first temperature (500° C.) to a second temperature (700° C.) (2° C./min) and then secondarily heat-treated for 10 hours to manufacture a cathode active material (Li_{1.03}Ni_{0.88}Co_{0.06}Mn_{0.06}O₂).

### Cathode Active Material According to Experimental Example 2

A cathode active material (Li_{1.03}Ni_{0.88}Co_{0.06}Mn_{0.06}O₂) according to experimental example 2 was manufactured in the same manner as in experimental example 1, except that the temperature of the secondary heat treatment was controlled to be 800° C. in a process of firing the cathode active material precursor and the lithium precursor.

### Cathode Active Material According to Comparative Example 1

A cathode active material precursor (Ni_{0.88}Co_{0.06}Mn_{0.06}(OH)₂) was prepared by a co-precipitation method (nitrogen atmosphere, 45.5° C., 900 rpm, pH 11 to 11.1, 24 hours) using a nickel sulfate solution (NiSO₄·6H₂O), a cobalt sulfate solution (CoSO₄·6H₂O), a manganese sulfate solution (MnSO₄·6H₂O), a chelating agent (NH₄OH), and a pH adjuster (NaOH).

After that, a firing process of the cathode active material precursor and the lithium precursor was performed in the same manner as in the cathode active material according to experimental example 1 to manufacture a cathode active material (Li_{1.03}Ni_{0.88}Co_{0.06}Mn_{0.06}O₂) according to comparative example 1.

### Cathode Active Material According to Comparative Example 2

A cathode active material (Li_{1.03}Ni_{0.88}Co_{0.06}Mn_{0.06}O₂), which was commercialized as a cathode active material and commercially available, was prepared.

### Half Cell According to Experimental Example 1

An aluminum foil was prepared as a cathode current collector, a cathode active material according to experimental example 1 was prepared as a cathode active material, a mixed powder of Super-P and KS-6 was prepared as a conductive material, and polyvinylidene fluoride (PVDF with N-methyl-2-pyrrolidone (NMP)) was prepared as a binder. In addition, the cathode active material, the conductive material, and the binder were mixed at a weight ratio of 85:7.5:7.5 to prepare a cathode slurry.

Then, 3 mg to 4 mg/cm⁻² of the cathode slurry was loaded on the cathode current collector to prepare a cathode.

After that, a separator (polypropylene (PP), celgard 2400 model) was disposed between the cathode and a graphite electrode, and an electrolyte (1.13 M LiPF6 in EC/DMC/DEC (3:4:3 volume ratio)) was provided to assemble a half cell.

### Half Cell According to Experimental Example 2

A half cell according to experimental example 2 was assembled in the same manner as in the half cell according to experimental example 1, except that a cathode active material according to experimental example 2 was prepared as the cathode active material.

### Half Cell According to Comparative Example 1

A half cell according to comparative example 1 was assembled in the same manner as in the half cell according to experimental example 1, except that a cathode active material according to comparative example 1 was prepared as the cathode active material.

### Half Cell According to Comparative Example 2

A half cell according to comparative example 2 was assembled in the same manner as in the half cell according to experimental example 1, except that a cathode active material according to comparative example 2 was prepared as the cathode active material.

### Full Cell According to Experimental Example 1

A cathode of the half cell according to experimental example 1 was prepared as a cathode, and an anode in which an anode slurry (including graphite) was loaded on an anode current collector (copper foil) was prepared. Specifically, an N/P ratio of the anode and the cathode was controlled to be 1.2.

After that, a separator (polypropylene (PP), celgard 2400 model) was disposed between the cathode and the anode, and an electrolyte (1.0 M LiPF₆ in EC/EMC (3:7 volume ratio with VC (2 wt %)) was provided to assemble a full cell.

Full Cell According to Comparative Example 1

A full cell according to comparative example 1 was assembled in the same manner as in the full cell according to experimental example 1, except that a cathode of a half cell according to comparative example 1 was prepared as a cathode.

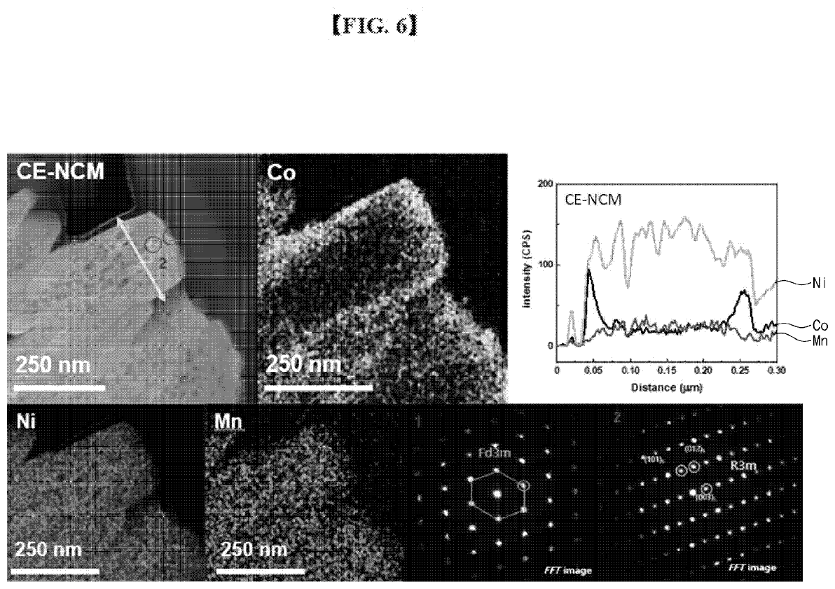

FIGS. 6 to 8 are pictures and graphs for comparing the surfaces and insides of cathode active materials according to experimental example 1, comparative example 1, and experimental example 2 of the present disclosure.

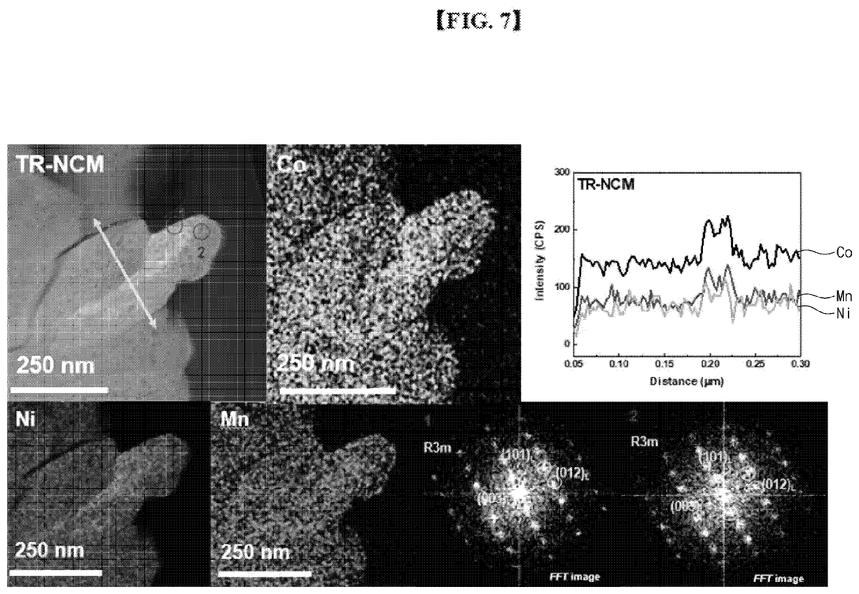

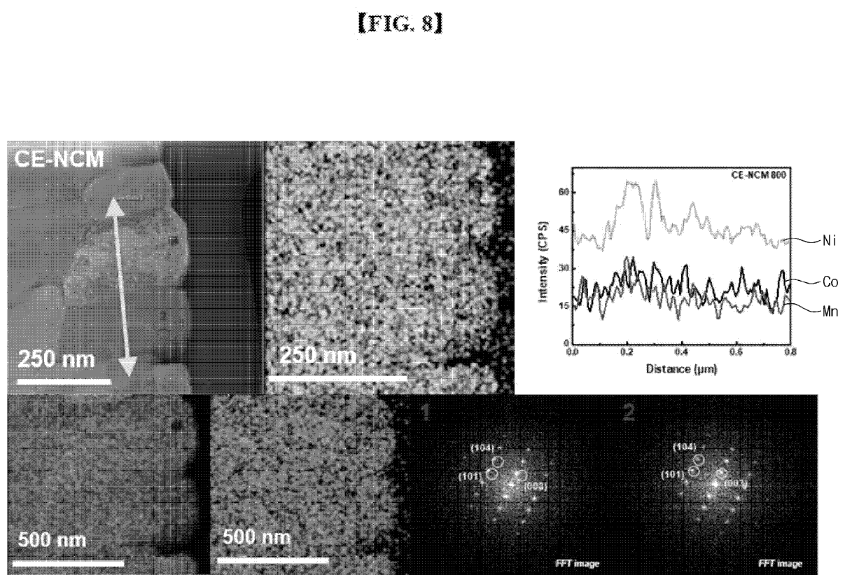

Referring to FIG. 6, the cathode active material (CE-NCM) according to experimental example 1 was photographed by TEM, and the distribution of transition metal elements (Ni, Co, Mn) on the surface and inside of the cathode active material (CE-NCM) according to experimental example 1 was mapped and analyzed by EDS. Referring to FIG. 7, the cathode active material (TR-NCM) according to comparative example 1 was photographed by TEM, and the distribution of transition metal elements (Ni, Co, Mn) on the surface and inside of the cathode active material (TR-NCM) according to comparative example 1 was mapped and analyzed by EDS. Referring to FIG. 8, the cathode active material (CE-NCM 800) according to experimental example 2 was photographed by TEM, and the distribution of transition metal elements (Ni, Co, Mn) on the surface and inside of the cathode active material (CE-NCM 800) according to experimental example 2 was mapped and analyzed by EDS.

As can be seen from FIGS. 6 to 8, it can be found that cobalt (Co) is distributed along the surface of the cathode active material according to experimental example 1, and it can be found that nickel (Ni) and manganese (Mn) are relatively more distributed in the inside of the cathode active material than cobalt (Co). In addition, it can be found that a crystal structure of a surface of the cathode active material according to experimental example 1 is a spinel structure, and a crystal structure of an inside of the cathode active material is a layered structure. In other words, it can be found that the crystal structures of the surface and inside of the cathode active material according to experimental example 1 are different. This factor may be interpreted as being due to the fact that cobalt (Co) is doped on the surface of the preliminary cathode active material precursor (Ni_{0.94}Mn_{0.06}(OH)₂).

In addition, it can be found that nickel, manganese, and cobalt are uniformly distributed on the surface and inside of the cathode active material according to comparative example 1. Furthermore, it can be found that the crystal structures of the surface and inside of the cathode active material according to comparative example 1 is a layered structure. This factor may be interpreted as being due to the fact that cobalt is not doped on the surface of the cathode active material precursor according to comparative example 1.

In addition, it can be found that nickel, manganese, and cobalt are uniformly distributed on the surface and inside of the cathode active material according to experimental example 2. Furthermore, it can be found that the surface and inside of the cathode active material according to experimental example 2 have a layered structure. This factor may be interpreted as being due to the fact that the secondary heat treatment temperature of the cathode active material precursor and lithium is controlled to be 800° C.

Thus, in the method for manufacturing a cathode active material according to an embodiment of the present application, a method for preparing a cathode active material precursor by doping cobalt on a surface of a preliminary cathode active material, and controlling a secondary heat treatment temperature of the cathode active material precursor to be at least 700° C. and less than 800° C. may be a method for differently controlling crystal structures of a surface and inside of a primary particle of a cathode active material.

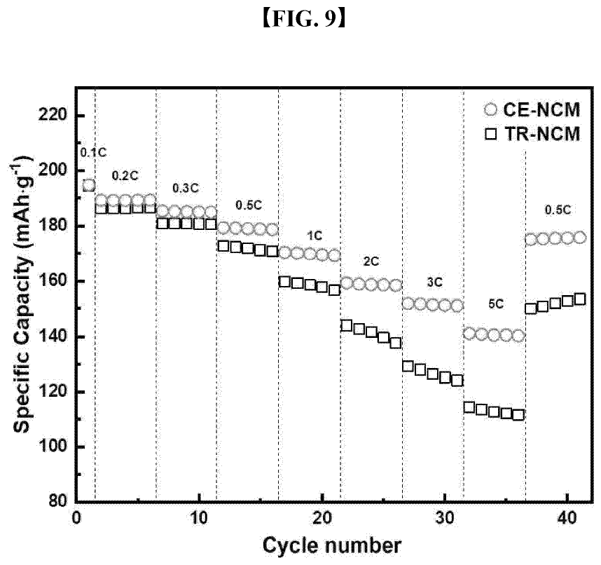

FIG. 9 is a graph for comparing the rate-limiting properties of half cells according to experimental example 1 and comparative example 1 of the present disclosure.

Referring to FIG. 9, the capacities of half cells according to experimental example 1 (CE-NCM) and comparative example 1 (TR-NCM) were measured according to charge/discharge speeds (0.1 C, 0.2 C, 0.3 C, 0.5 C, 1 C, 2 C, 3 C, 5 C, 0.5 C).

As can be seen from FIG. 9, it can be found that the half cell according to experimental example 1 has a more excellent rate-limiting property under charge/discharge conditions (0.5 C to 5 C) than that of the half cell according to experimental example 2.

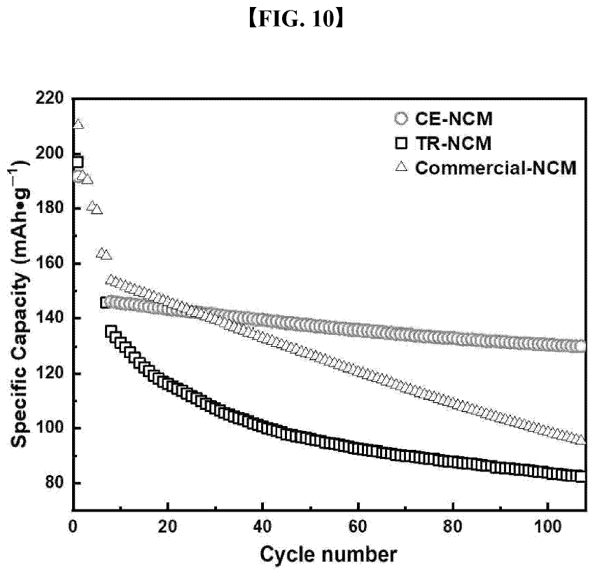

FIG. 10 is a graph for comparing the stabilities of half cells against charge/discharge cycles according to experimental example 1 and comparative example 2 of the present disclosure.

Referring to FIG. 10, the capacities of half cells according to experimental example 1 (CE-NCM), comparative example 1 (TR-NCM), and comparative example 2 (Commercial-NCM) were measured while performing 100 charge/discharge cycles (charge/discharge cycle conditions: 0.1 C (formation cycle), 0.5 C (2 cycles), 1 C (2 cycles), 3 C (2 cycles), and 5 C (100 cycles)) in a range of 2.7 V to 4.3 V.

As can be seen from FIG. 10, it can be found that a capacity retention rate of the half cell according to experimental example 1 is 89% under the condition of 5 C, which is significantly more excellent than a capacity retention rate of the half cells according to comparative examples 1 and 2.

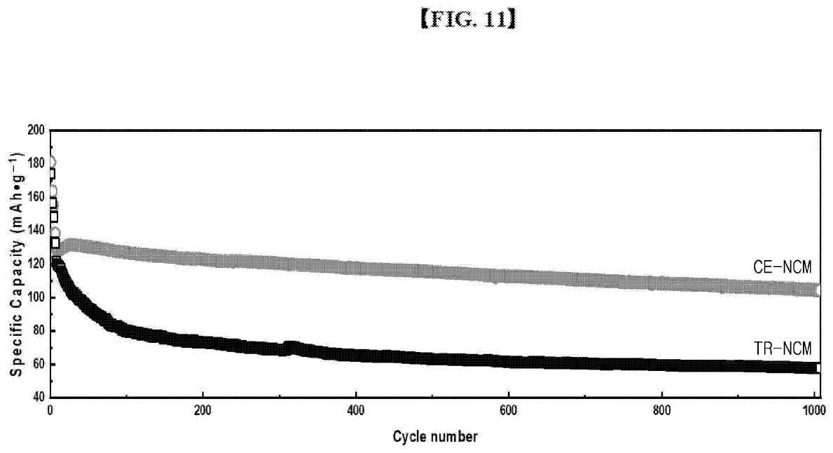

FIG. 11 is a graph for comparing the stabilities of full cells against charge/discharge cycles according to experimental example 1 and comparative example 1 of the present disclosure.

Referring to FIG. 11, the capacities of full cells according to experimental example 1 (CE-NCM) and comparative example 1 (TR-NCM) were measured while performing 1,000 charge/discharge cycles (charge/discharge cycle conditions: 0.1C (formation cycle), 0.5 C (2 cycles), 1 C (2 cycles), 3 C (2 cycles), and 5 C (100 cycles)) in a range of 3.0 V to 4.2 V.

As can be seen from FIG. 11, it can be found that a capacity retention rate of the full cell according to experimental example 1 is 90% under the condition of 5 C, which is significantly more excellent than a capacity retention rate of the full cell according to comparative example 1.

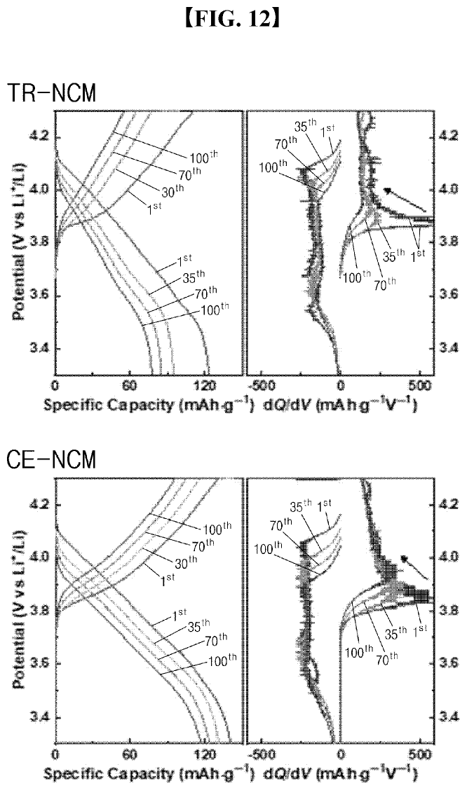

FIG. 12 is a graph for comparing the stabilities of crystal structures during charge/discharge processes of half cells according to comparative example 1 and experimental example 1 of the present disclosure.

Referring to FIG. 12, half cells according to comparative example 1 (TR-NCM) and experimental example 1 (CE-NCM) were subjected to 100 charge/discharge cycles under the conditions described above in FIG. 10, and the results thereof are shown as a dq/dv curve.

As can be seen from FIG. 12, it can be found that the cathode active material of the half cell according to experimental example 1 has a significantly smaller change in a crystal structure than that of the cathode active material of the half cell according to comparative example 1, with regard to the charge/discharge cycle (1 cycle to 100 cycles) under the 5 C condition.

Comprehensively, referring to FIGS. 9 to 12, it can be found that the half cell and the full cell with the cathode active material according to experimental example 1 applied thereto have a more excellent rate-limiting property and long-term stability against the charge/discharge cycles than those of comparative examples. This factor may be interpreted as being due to the fact that the surface of the cathode active material according to experimental example 1 has a spinel structure and the inside thereof has a layered structure. Accordingly, it can be found that discharge capacity and energy density are improved during charge/discharge processes due to a layered structure of the inside of the cathode active material according to experiment example 1, the spinel structure of the surface of the cathode active material according to experimental example 1 acts as a passivation layer, and a three-dimensional channel shape for lithium ion diffusion is provided to significantly improve the rate-limiting property for high speed charge/discharge speeds, and long-term stability against the charge/discharge cycles.

FIGS. 13 and 14 are TEM pictures for comparing the crystal structures of cathode active materials after charge/discharge of half cells according to experimental example 1 and comparative example 1 of the present disclosure.

Referring to FIG. 13, the half cell according to experimental example 1 (CE-NCM) was subjected to 100 charge/discharge cycles under the condition described in FIG. 10, and then the cathode active material of the half cell according to experimental example 1 (CE-NCM) was photographed by TEM. Referring to FIG. 14, the half cell according to comparative example 1 (TR-NCM) was subjected to 100 charge/discharge cycles under the condition described in FIG. 10, and then the cathode active material of the half cell according to comparative example 1 (TR-NCM) was photographed by TEM.

As can be seen from FIGS. 13 and 14, it can be found that the spinel structure present at a distance of 9.4 nm or less from the surface of the cathode active material of the half cell according to experimental example 1 is converted into the rock salt structure during 100 charge/discharge cycles. In addition, it can be found that a unique crystal structure (internal: layered structure, external: spinel structure) of the cathode active material is maintained, except that the crystal structure of the cathode active material of the half cell according to experimental example 1 is partially converted into a rock salt structure.

Then, it can be found that the layered structure present at a distance of 16.1 nm or less from the surface of the cathode active material of the half cell according to comparative example 1 is converted into the rock salt structure during charge/discharge processes.

Accordingly, it can be found that side reactions occurring at an interface between the cathode active material and electrolyte are more effectively suppressed in the cathode active material of the half cell according to experimental example 1 than in the cathode active material of the half cell according to comparative example 1.

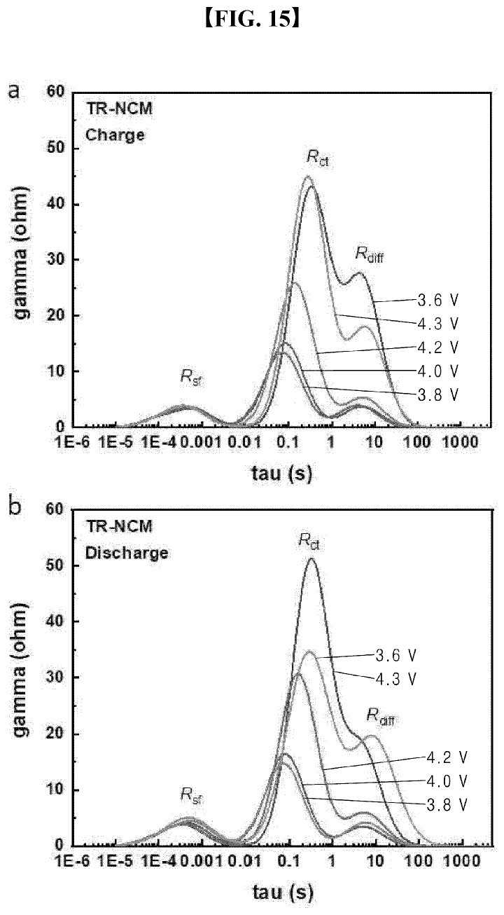

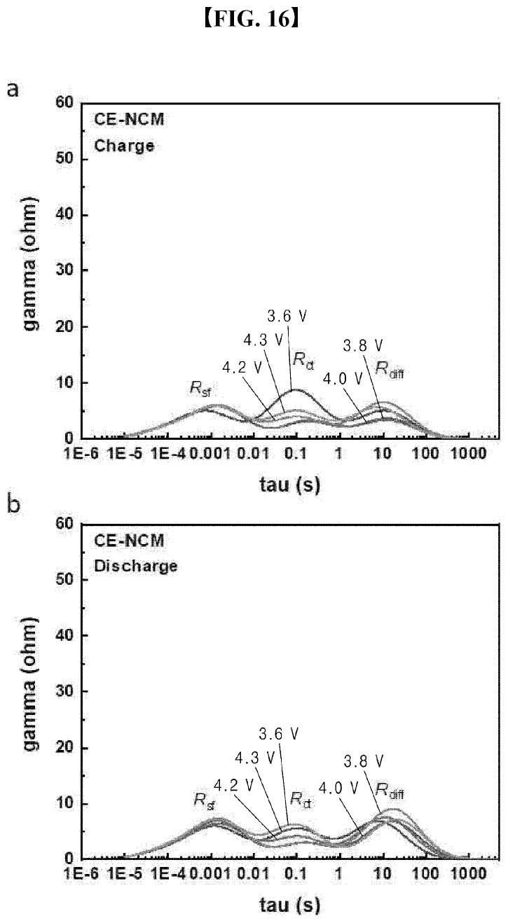

FIGS. 15 and 16 are graphs for comparing the resistance values against charge/discharge after performing charge/discharge of half cells according to comparative example 1 and experimental example 1 of the present disclosure.

Referring to FIG. 15, after the half cell (TR-NCM) according to comparative example 1 is subjected to 100 charge/discharge cycles under the conditions described above in FIG. 10, electrochemical impedance spectroscopy (EIS) analysis was performed while charging/discharging the half cell (TR-NCM) according to comparative example 1, and a frequency was expressed as a distribution of relaxation times (DRT) graph by Fourier transform in time. Referring to FIG. 16, after the half cell (CE-NCM) according to experimental example 1 is subjected to 100 charge/discharge cycles under the conditions described above in FIG. 10, an EIS analysis was performed while charging/discharging the half cell (CE-NCM) according to experimental example 1, and a frequency was expressed as a DRT graph by Fourier transform in time.

As seen from FIGS. 15 and 16, it can be found that the half cell according to experimental example 1 has a significantly lower charge transfer resistance (R_{ct}) value for charge/discharge under voltage conditions (3.6 V to 4.3 V) than that of the half cell according to comparative example 1.

This factor may be interpreted as being due to the fact that the electrolyte is decomposed during 100 charge/discharge processes due to instability of the interface between electrolyte and the cathode active material of the half cell according to comparative example 1, and thus more organic matter layers are formed at the interface than inorganic matter layers, but more inorganic matter layers are formed at the interface during 100 charge/discharge processes due to stability of the interface between electrolyte and the cathode active material of the half cell according to experimental example 1.

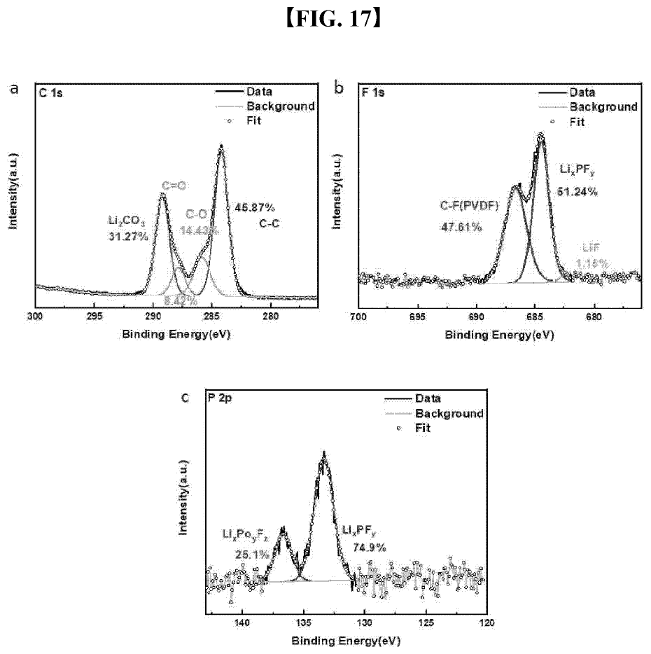

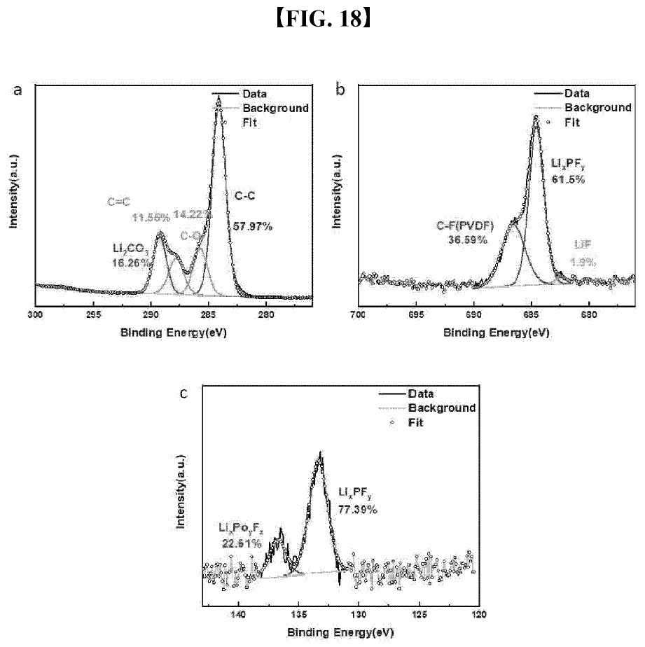

FIGS. 17 and 18 are graphs for comparing the amounts of organic and inorganic matter layers on the surfaces of cathode active materials after charge/discharge of half cells according to comparative example 1 and experimental example 1 of the present disclosure.

Referring to FIG. 17, after the half cell (TR-NCM) according to comparative example 1 is subjected to 100 charge/discharge cycles under the conditions described above in FIG. 10, an XPS analysis was performed on the cathode active material of the half cell (TR-NCM) according to comparative example 1 with respect to C 1s spectrum (a of FIG. 17), F 1s spectrum (b of FIG. 17), and P 2p spectrum (c of FIG. 17). Referring to FIG. 18, after the half cell (CE-NCM) according to experimental example 1 is subjected to 100 charge/discharge cycles under the conditions described above in FIG. 10, an XPS analysis was performed on the cathode active material of the half cell (CE-NCM) according to experimental example 1 with respect to C 1s spectrum (a of FIG. 18), F 1s spectrum (b of FIG. 18), and P 2p spectrum (c of FIG. 18).

As can be seen from FIGS. 17 and 18, it can be found that an inorganic matter layer on the surface of the cathode active material of the half cell according to experimental example 1 is more than the inorganic matter layer on the surface of the cathode active material of the half cell according to comparative example 1.

The organic matter layer (Li₂CO₃, C═O) on the surface of the cathode active material may increase an interfacial resistance of the interface between the cathode active material and the electrolyte, but the inorganic matter layer (LiₓPF_{y}, LiF) on the surface of the cathode active material has higher ionic conductivity than that of the organic matter layer and may function as a passivation layer.

Accordingly, it can be found that the interface between the electrolyte and the cathode active material of the half cell according to experimental example 1 has a more excellent interface stability than that of the interface between the electrolyte and the cathode active material of the half cell according to comparative example 1.

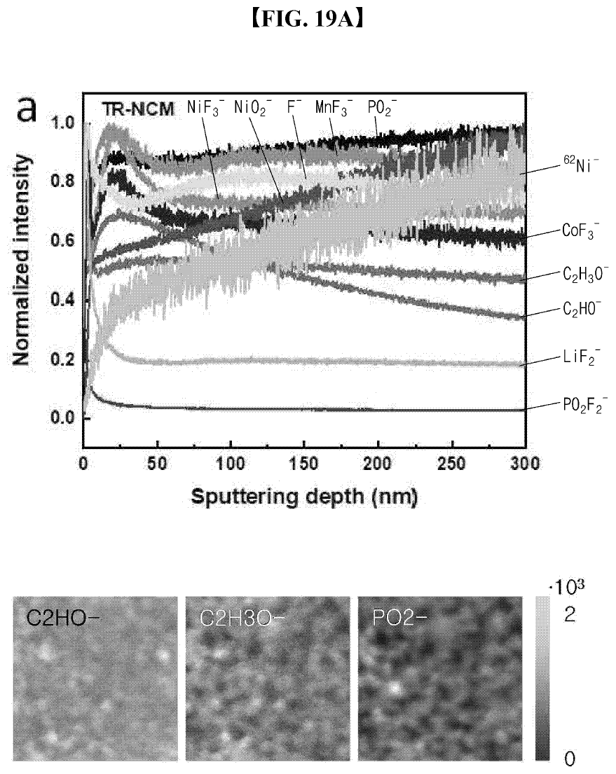

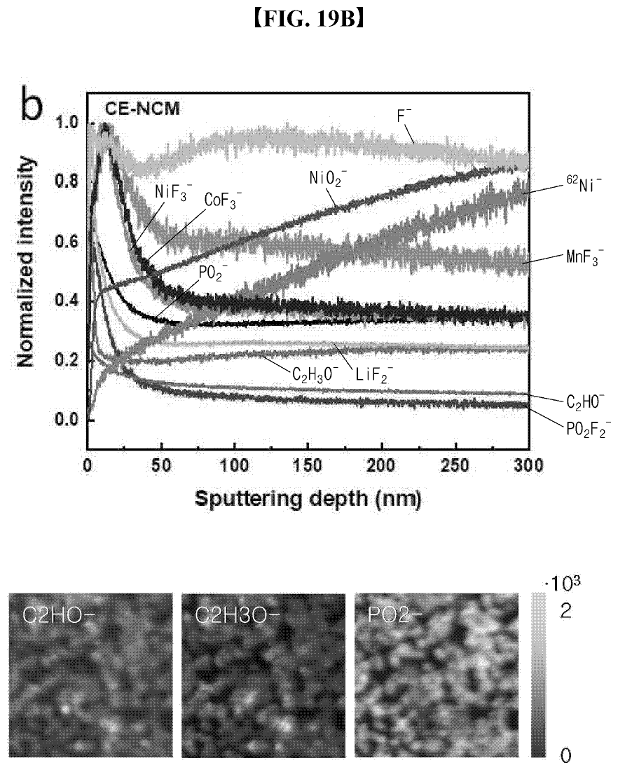

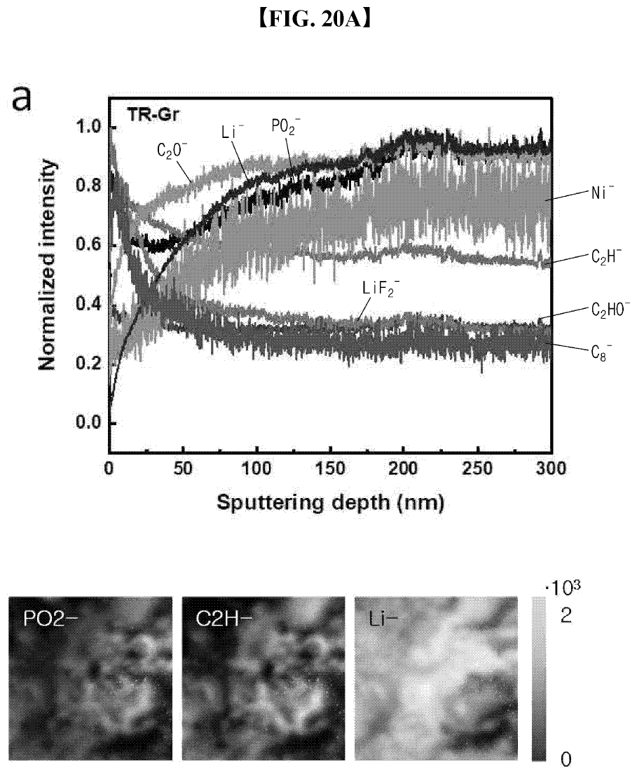

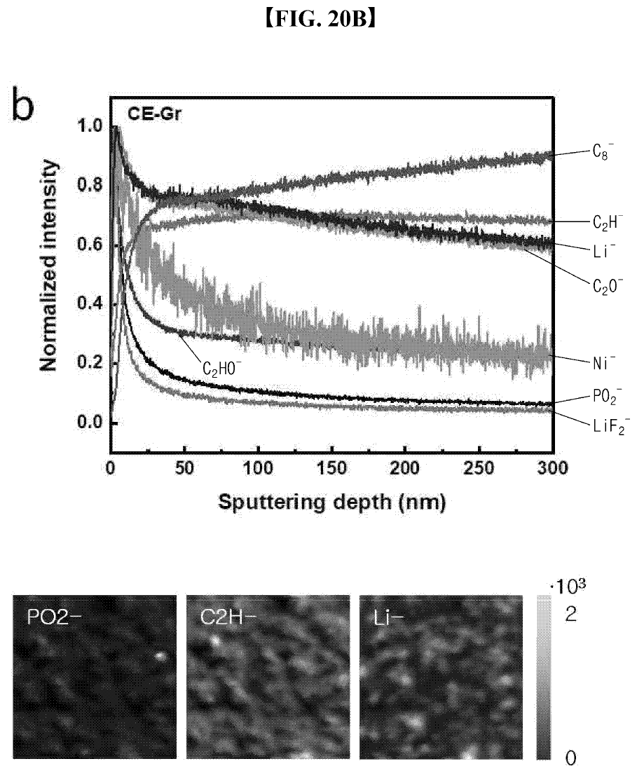

FIGS. 19A-19B and 20A-20B show results of time of flight secondary ion mass spectrometry (TOF-SIMS) analysis on cathodes and anodes after charge/discharge of full cells according to comparative example 1 and experimental example 1 of the present disclosure.

Referring to FIGS. 19A and 19B, after the full cells according to comparative example 1 (TR-NCM) and experimental example 1 (CE-NMC) are subjected to 1,000 charge/discharge cycles under the conditions described above in FIG. 11, a TOF-SIMS analysis was performed on by-products formed on the surface of the cathode active materials of the full cells according to comparative example 1 (TR-NCM) and experimental example 1 (CE-NMC). Referring to FIGS. 20A and 20B, after the full cells according to comparative example 1 (TR-NCM) and experimental example 1 (CE-NMC) are subjected to 1,000 charge/discharge cycles under the conditions described above in FIG. 11, a TOF-SIMS analysis was performed on by-products formed on the surface of the anode active materials (graphite) of the full cells according to comparative example 1 (TR-NCM) and experimental example 1 (CE-NMC).

As can be seen from FIGS. 19A-19B and 20A-20B, it can be found that the full cell according to experimental example 1 has a more amount of by-products formed on the surface of the cathode active material than that of the full cell according to comparative example 1. This factor may be interpreted as being due to the fact that nickel is exposed on the surface of the cathode active material of the full cell according to comparative example 1, but cobalt is doped on the surface of the cathode active material of the full cell according to experimental example 1 to prevent the nickel from being exposed.

In addition, it can be found that the full cell according to experimental example 1 has a less amount of by-products formed on the surface of the anode active material than that of the full cell according to comparative example 1 and the formation of lithium dendrites is effectively suppressed.

Thus, it can be found that the stability of the interface between the cathode active material and the electrolyte is improved during the charge/discharge processes by the cobalt doped on the surface of primary particle of the cathode active material according to an embodiment of the present application, and thus the formation of by-products on the surfaces of the cathode and the anode of the full cell is suppressed, and the formation of lithium dendrites on the surface of the anode is effectively suppressed.

Although the present disclosure has been described in detail using preferred embodiments, the scope of the present disclosure is not limited to specific embodiments, and should be interpreted by the appended claims. In addition, it should be understood by those skilled in the art that many modifications and variations are possible without departing from the scope of the present disclosure.

### INDUSTRIAL APPLICABILITY

A cathode active material according to an embodiment of the present disclosure may be used in various devices such as a lithium ion battery, an electric vehicle, a mobile device, an ESS, etc.

What is claimed is:

1. A method for manufacturing a cathode active material, the method comprising:
preparing a preliminary cathode active material precursor containing nickel and manganese;
preparing a doping source containing cobalt;
providing the preliminary cathode active material precursor into the doping source, followed by refluxing reaction, thereby preparing a cathode active material precursor; and
mixing the cathode active material precursor and a lithium precursor, followed by firing, thereby manufacturing the cathode active material.

2. The method of claim 1, wherein a crystal structure of a surface of a primary particle of the cathode active material and a crystal structure of an inside thereof are differently controlled by the manufacturing of the cathode active material precursor.

3. The method of claim 2, wherein in the manufacturing of the cathode active material precursor, a refluxing reaction temperature is controlled to be 84° C. or less, and a refluxing reaction time is controlled to be eight hours or less.

4. The method of claim 1, wherein the preliminary cathode active material is a transition metal hydroxide containing nickel and manganese, and
the doping source is a cobalt nitrate solution.

5. A method for manufacturing a cathode active material, the method comprising: doping cobalt on a surface of a transition metal hydroxide containing nickel and manganese to manufacture a cathode active material precursor, followed by firing together with a lithium precursor, wherein
the cathode active material precursor is primarily heat-treated at a first temperature, and the primarily heat-treated cathode active material precursor is secondarily heat-treated at a second temperature higher than the first temperature, and
crystal structures of a surface and inside of a primary particle of the cathode active material are differently and identically controlled according to the second temperature.

6. The method of claim 5, wherein the second temperature is controlled to be at least 700° C. and less than 800° C., in which the crystal structure of the inside of the primary particle of the cathode active material is controlled to have a layered structure, and the crystal structure of the surface thereof is controlled to have a spinel structure by cobalt.

7. The method of claim 6, wherein a rate-limiting property and stability against charge/discharge cycles are improved under a condition of 5 C by the different crystal structures of the surface and inside of the primary particle of the cathode active material.

8. A cathode active material having cobalt doped on a surface of a composite metal oxide containing lithium, nickel, and manganese, wherein
crystal structures of a surface and inside of a primary particle of the cathode active material are different from each other,
the inside of the primary particle has a layered structure, and
the surface of the primary particle has a spinel structure.

9. The cathode active material of claim 8, wherein the crystal structure of the surface of the cathode active material is converted into a rock salt structure when a charge/discharge cycle is performed on the cathode active material.

10. The cathode active material of claim 9, wherein the spinel structure present at a distance of 9.4 nm or less from the surface of the cathode active material is converted into the rock salt structure when 100 charge/discharge cycles are performed on the cathode active material under a condition of 5 C.
